(19) United States
(12) Patent Application Publication
(10) Pub. No.: US 2010/0161708 A1
(43) Pub. Date: Jun. 24, 2010

(54) SYSTEM OF PROVIDING CONTENTS INFORMATION ON IDLE-MODE SCREEN OF MOBILE TERMINAL USING PERSONAL COMPUTER OF FUNCTIONING AS SERVER, METHOD THEREOF AND COMPUTER READABLE RECORD MEDIUM ON WHICH PROGRAM FOR EXECUTING METHOD IS RECORDED

(76) Inventor: Chang Seok LEE, Seoul (KR)

Correspondence Address: Cozen O''''Connor, 277 Park Avenue, 20th Floor, New York, NY, 10172, US

(21) Appl. No.: 11/816,378

(22) PCT Filed: Feb. 23, 2005
(86) PCT No.: PCT/KR2005/000495

§ 371 Date: Aug. 15, 2007

(30) Foreign Application Priority Data
Feb. 17, 2005 (KR) 10-2005-0013296

(51) Int. Cl. G06F 15/16

(52) U.S. Cl. 709/203

(57) ABSTRACT

An idle-mode service system, and more particularly, to a service system in which a personal computer is used as peer to peer (P2P)/WEB to phone (W2P) to provide contents on the idle-mode screen of a mobile communication terminal is provided. A system of providing contents information on the idle-mode screen of a mobile communication terminal using a personal computer that functions as a server comprises an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen.

### TECHNICAL FIELD

The present invention relates to an idle-mode service system, and more particularly, to a service system in which a personal computer is used as peer to peer (P2P)/WEB to phone (W2P) to provide contents on the idle-mode screen of a mobile communication terminal.

### BACKGROUND ART

The applicant of the present invention filed Korean Patent Registration No. 10-0391291 that is entitled “Mobile Communication Terminal Having the Function of Notice Board, Method of Driving the Same, and Notice Board Service Method and System Using the Same” and International Patent Application No. PCT/KR2004/000897 that is entitled “Method and Apparatus for Controlling and Managing Idle Screen Resources for Mobile Communication Terminal”.

According to the Korean Patent Registration No. 10-0391291, it is possible to store useful information in a user mobile communication terminal, to periodically display the stored information, and to continuously check the use of the useful information that is provided to a user so that it is possible to maximize the effect of the use of information. However, it is not described to extract and change on line contents so that a user selectively uses desired information. In the International Patent Application No. PCT/KR2004/000897, resources on the idle mode screen of a mobile communication terminal and formation of the idle screen are described. However, it is not described to extract and change the on line contents so that the user selectively uses the desired information.

### DISCLOSURE OF INVENTION

### Technical Problem

Therefore, the present invention has been made in view of the above and/or other problems, and it is an object of the present invention to provide an idle-mode service system, and more particularly, a service system in which a personal computer is used as peer to peer (P2P)/WEB to phone (W2P) to provide contents on the idle-mode screen of a mobile communication terminal.

The applicant of the present invention filed Korean Patent Registration No. 10-0391291 that is entitled “Mobile Communication Terminal Having the Function of Notice Board, Method of Driving the Same, and Notice Board Service Method and System Using the Same” and International Patent Application No. PCT/KR2004/000897 that is entitled “Method and Apparatus for Controlling and Managing Idle Screen Resources for Mobile Communication Terminal”.

According to the Korean Patent Registration No. 10-0391291, it is possible to store useful information in a user mobile communication terminal, to periodically display the stored information, and to continuously check the use of the useful information that is provided to a user so that it is possible to maximize the effect of the use of information. However, it is not described to extract and change on line contents so that a user selectively uses desired information. In the International Patent Application No. PCT/KR2004/000897, resources on the idle mode screen of a mobile communication terminal and formation of the idle screen are described. However, it is not described to extract and change the on line contents so that the user selectively uses the desired information.

### Technical Solution

In accordance with the present invention, the above and other aspects can be accomplished by the provision of a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen.

The system preferably further comprises the gateway of a mobile communication company to transmit contents data that is communicated between the personal computer and the mobile communication terminal.

The mobile communication terminal preferably receives contents information in a push or pull method.

The contents extraction/conversion programs preferably extract the contents of a service server to convert the extracted contents into extensible markup language (XML) data that is easily managed and operated.

There is provided a method of extracting/converting contents in a personal computer using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of (a) initializing the contents to data standard and specification that are suitable for a mobile communication terminal, (b) inputting a uniform resource locator (URL) to be extracted through the contents extraction/conversion programs, (c) buffering data that is transmitted to a hypertext transfer protocol (HTTP) corresponding to the URL in a temporary storage space, (d) processing the buffered data so that the contents region is easily extracted, (e) providing the processed contents on a mobile communication terminal screen, (f) selecting a region that is desired to be extracted from the screen on which the processed contents are provided, and (g) the contents extraction/conversion programs converting the processed contents into data standard and specification that are suitable for a mobile communication terminal.

The method further comprises the steps of (h) the contents extraction/conversion programs processing contents data to data that is easily managed and operated, (i) the contents data formed of channels creating a database (DB) region to store the contents in the created DB region, and (j) the contents extraction/conversion programs checking an emulated screen on which on line contents are displayed by the emulator of a mobile communication terminal.

The data that is easily managed and operated in the step (h) is preferably XML.

There is provided a method of transmitting contents from a personal computer to a mobile communication terminal using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of (a) selecting contents to be displayed on the idle-mode screen of a mobile communication terminal, (b) setting profiles for a selected channel corresponding to the contents to be displayed, and (c) transmitting contents based on the profiles in accordance with the format of the mobile communication terminal.

The profiles of the step (c) preferably comprise at least one of a period in which broadcasting is performed on the idle-mode screen in the personal multimedia broadcasting system, invocation time, a contents available period, and the generation of real time information.

There is provided a computer readable recording medium on which programs are recorded, the programs for executing a method of extracting/converting contents in a personal computer using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of (a) initializing the contents to data standard and specification that are suitable for a mobile communication terminal, (b) inputting a uniform resource locator (URL) to be extracted through the contents extraction/conversion programs, (c) buffering data that is transmitted to a hypertext transfer protocol (HTTP) corresponding to the URL in a temporary storage space, (d) processing the buffered data so that the contents region is easily extracted, (e) providing the processed contents on a mobile communication terminal screen, (f) selecting a region that is desired to be extracted from the screen on which the processed contents are provided, and (g) the contents extraction/conversion programs converting the processed contents into data standard and specification that are suitable for a mobile communication terminal.

There is provided a computer readable recording medium on which programs are recorded, the programs for executing a method of transmitting contents from a personal computer to a mobile communication terminal using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of (a) selecting contents to be displayed on the idle-mode screen of a mobile communication terminal, (b) setting profiles for a selected channel corresponding to the contents to be displayed, and (c) transmitting contents based on the profiles in accordance with the format of the mobile communication terminal.

### ADVANTAGEOUS EFFECTS

According to the present invention, it is possible to provide personalized contents service system and method that are capable of easily extracting a necessary part from on line contents and of easily processing the extracted data.

Also, according to the present invention, it is possible to provide various contents on the mobile communication terminal idle-mode screens of a plurality of users using a personal computer.

### BRIEF DESCRIPTION OF THE DRAWINGS

FIG. 1 illustrates a system of providing contents information on the idle-mode screen of a mobile communication terminal using a personal computer that functions as a server according to the present invention;

FIG. 2 is a flowchart illustrating a method of extracting and changing contents in order to provide contents information on the idle-mode screen of a mobile communication terminal using the personal computer that functions as a server according to the present invention; and

FIG. 3 is a flowchart illustrating a method of performing an idle-mode service on line contents by the mobile communication terminal in an idle mode service system that uses the personal computer according to the present invention.

### BEST MODE FOR CARRYING OUT THE INVENTION

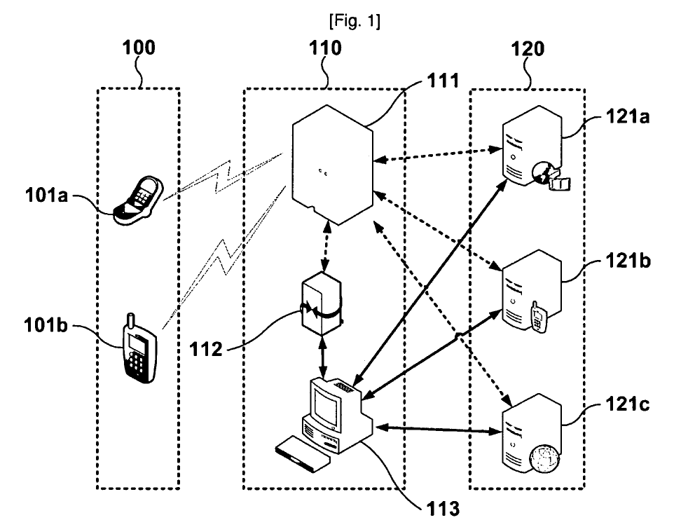

FIG. 1 illustrates a system of providing contents information on the idle-mode screen of a mobile communication terminal using a personal computer that functions as a server according to the present invention.

As illustrated in FIG. 1, a system of providing contents information on the idle-mode screen of a mobile communication terminal using a personal computer that functions as a server according to the present invention comprises a mobile communication terminal 100, a service server 110, and an on line portal server 120.

An idle-mode service is supported to the mobile communication terminals 101a and 101b.

The service server 110 comprises a mobile communication company server 111, a gateway 112, and a personal computer 113.

The gateway 112 collects the data that is transmitted by the personal computer 113 to transmit the collected data to the mobile communication company server 111.

The on line portal server 120 may comprise various on line servers such as a streaming server 121a, a mobile contents server 121b, and a web server 121c.

The internal structures of the mobile communication company server 111 and the gateway 112 are not described but method and system of performing a real time idle-mode service among the on line portal server 120, the personal computer 113, and the mobile communication terminal 100 and a recording medium on which programs are stored will be described.

Contents extraction/conversion programs that enable on line contents to be converted into a format that is optimal to the mobile communication terminal 100 in order to extract the on line contents from the on line portal server 120 or to transmit the on line contents to the mobile communication terminal 100 are stored in the personal computer 113.

The contents extraction/conversion programs can select a web page from which contents are to be extracted when a user inputs a uniform resource locator (URL) to be extracted and can obtain the stream of a hypertext transfer protocol (HTTP) corresponding to the URL to read contents region, script, image, and meta data and to buffer the contents region, script, image, and meta data in a temporary storage space.

Also, the contents extraction/conversion programs can process the buffered data so that a user can easily select and extract the contents region from the buffered data.

The contents extraction/conversion programs can be converted into data standard and specification that are suitable for the mobile communication terminal that is initially set by the user.

Also, the contents extraction/conversion programs can process contents data to data that is easily managed and operated to create channels and can provide the idle screen template of a mobile communication terminal in order to easily form a screen on which various types of contents are displayed.

Extensible markup language (XML) data is preferably used as the data that can be managed and operated.

According to a contents service system using a personal computer in which the above-described contents extraction/conversion programs are built in, a contents service user can extract and use the contents that are provided by the on line portal server 120 through the personal computer 113 and can convert the contents.

Also, the contents of the on line portal server 120 can be extracted through the personal computer 113 and can be stored in the personal computer 113 by channel.

The personal computer 113 can process the contents to be suitable for the mobile communication terminal 100 that is initially set and the processed contents are provided from the personal computer 113 to the mobile communication terminal 100 through the Internet in the form of an idle-mode screen.

That is, the personal computer 113 receives and manages the contents that are processed to be suitable for the mobile communication terminal 100 in the form of W2P by a predetermined logic program and a user receives the contents from the personal computer 113 through the plurality of mobile communication terminals 100.

The contents mean real time multimedia on line contents such as portal communities, e-mails, Internet broadcasting, stocks, and auctions.

According to such a structure, the personal computer can extract multimedia on line contents to operate a personalized database (DB), can transmit the multimedia on line contents to the mobile communication terminal thereof or a mobile communication terminal of a third party and synchronize the multimedia on line contents, and can form a personalized radio patch service system in which the personal computer thereof is used as a network center.

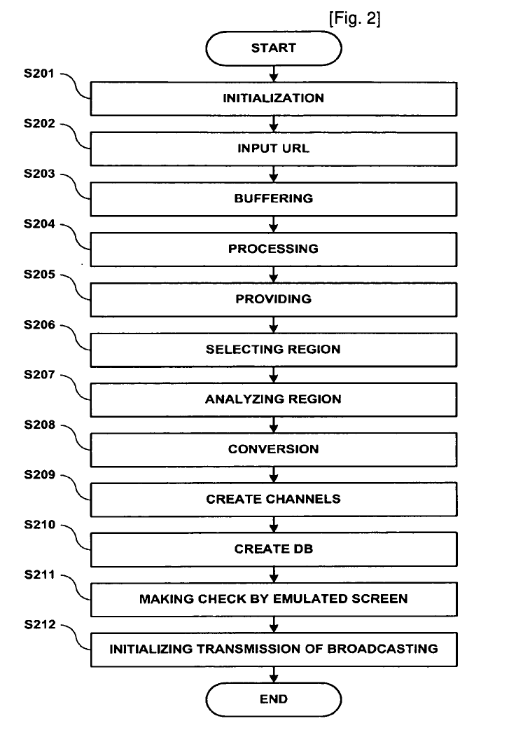

FIG. 2 is a flowchart illustrating a method of extracting and changing contents in order to provide contents information on the idle-mode screen of a mobile communication terminal using the personal computer that functions as a server according to the present invention.

As illustrated in FIG. 2, in the first step of extracting the on line contents, the on line contents extraction/conversion programs are executed by the personal computer.

The user performs initialization to the data standard and specification that are suitable for the mobile communication terminal in order to extract the contents from on line and to provide the extracted contents to the personal computer (S201).

The user inputs the URL to be extracted from the contents extraction/conversion programs (S202) to select a web page from which the contents are to be extracted.

The contents extraction/conversion programs obtain the stream of the HTTP corresponding to the URL that is input by the user to read the contents region, script, image, and meta data to buffer the contents region, script, image, and meta data in the temporary storage space (S203).

The contents extraction/conversion programs process the buffered data so that the user easily selects and extracts the contents region (S204) and provide a processed contents screen to the user (S205).

The user selects the region that is desired to be extracted in the processed contents screen that is provided by the contents extraction/conversion programs (S206).

The contents extraction/conversion programs analyze the contents region that is selected by the user (S207) to convert the contents region into the data standard and specification that are suitable for the mobile communication terminal that is initially set by the user (S208).

The contents extraction/conversion programs process the contents data to the data that can be easily managed and operated to create the channels (S209).

The XML data is preferably used as the data that can be easily managed and operated.

The contents data is processed to the XML data because the contents data can be easily extracted and converted from the contents extraction/conversion programs using the mark-up tag of the XML and various XML parsers.

The contents data that is formed of the channels creates the DB region of the user computer to store the contents in the created DB region (S210).

The contents extraction/conversion programs can check an emulated screen on which the processed on line contents are served by the emulator of the mobile communication (S211).

Processed contents data that is made optimal to the mobile communication terminal and that is stored is displayed on the user computer screen by the emulator of the mobile communication terminal so that the user can first check the way how the processed on line contents are displayed on the mobile communication terminal by an emulated screen (S211).

The contents extraction/conversion programs provide various templates for the idle screen of the mobile communication terminal in order to easily display the various types of contents on the screen.

The user checks the emulated screen that is provided by the contents extraction/conversion programs to perform initialization for the transmission of broadcasting (S212).

That is, a unique channel ID for broadcasting, a transmission period in which transmission to the mobile communication terminal is performed, selection of a contents channel, user information that is specified to the user, and profiles are set.

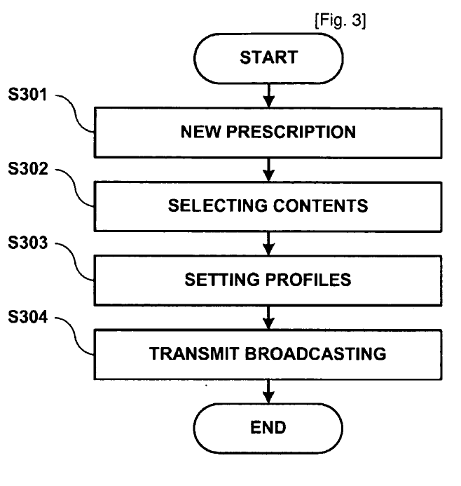

FIG. 3 is a flowchart illustrating a method of performing an idle-mode service on line contents by the mobile communication terminal in an idle mode service system that uses the personal computer according to the present invention.

The contents user transmits items on the mobile communication terminal to a personal multimedia broadcasting system through the Internet to make a new prescription for being served later (S301).

The contents user selects contents to receive broadcasting on the idle-mode screen of the mobile communication terminal thereof (S302).

The method that is described with reference to FIG. 2 is used as a method of the contents user extracting and converting the contents that are selected for broadcasting reception.

The contents user sets profiles for the channel that is selected for broadcasting reception (S303).

Various profiles such as a period in which broadcasting is performed on the idle-mode screen in the personal multimedia broadcasting system, invocation time, a contents available period, and the generation of real time information are set.

Also, a service policy on whether the mobile communication terminal receives the contents from the personal multimedia broadcasting system or directly receives from the contents server is set in the profiles.

When all of the above are set, broadcasting is transmitted to each user at the point of time where the contents information is broadcasted to the next contents user using the ID of each user that is stored in the DB of the personal multimedia broadcasting system based on the profiles that are set in accordance with the user information and the mobile communication terminal of the user (S304).

The present invention has been described with reference to the accompanying drawings, in which preferred embodiments of the invention are shown. This invention may, however, be embodied in many different forms and should not be construed as being limited to the embodiments.

While this invention has been particularly shown and described with reference to preferred embodiments thereof, it will be understood by those skilled in the art that various changes in form and details may be made therein without departing from the spirit and scope of the invention as defined by the appended claims. Therefore, this invention should not be construed as being limited to the embodiments.

1. A system of providing contents information on the idle-mode screen of a mobile communication terminal using a personal computer that functions as a server, the system comprising:
an on line portal server for providing contents to a personal computer through a communication network;
a personal computer in which contents extraction/conversion programs for extracting contents from the on line portal server to convert the extracted contents to be displayed on the idle-mode screen of the mobile communication terminal are built; and
a mobile communication terminal for receiving the contents from the personal computer to display the received contents on the idle-mode screen.

2. The system as claimed in claim 1, further comprising the gateway of a mobile communication company to transmit contents data that is communicated between the personal computer and the mobile communication terminal.

3. The system as claimed in claim 1, wherein the mobile communication terminal receives contents information in a push or pull method.

4. The system as claimed in claim 1, wherein the contents extraction/conversion programs extract the contents of a service server to convert the extracted contents into extensible markup language (XML) data that is easily managed and operated.

5. A method of extracting/converting contents in a personal computer using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of:
(a) initializing the contents to data standard and specification that are suitable for a mobile communication terminal;
(b) inputting a uniform resource locator (URL) to be extracted through the contents extraction/conversion programs;
(c) buffering data that is transmitted to a hypertext transfer protocol (HTTP) corresponding to the URL in a temporary storage space;
(d) processing the buffered data so that the contents region is easily extracted;
(e) providing the processed contents on a mobile communication terminal screen;
(f) selecting a region that is desired to be extracted from the screen on which the processed contents are provided; and
(g) the contents extraction/conversion programs converting the processed contents into data standard and specification that are suitable for a mobile communication terminal.

6. The method as claimed in claim 5, further comprising the steps of:
(h) the contents extraction/conversion programs processing contents data to data that is easily managed and operated;
(i) the contents data formed of channels creating a database (DB) region to store the contents in the created DB region; and
(j) the contents extraction/conversion programs checking an emulated screen on which on line contents are displayed by the emulator of a mobile communication terminal.

7. The method as claimed in claim 6, wherein the data that is easily managed and operated in the step (h) is XML.

8. A method of transmitting contents from a personal computer to a mobile communication terminal using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of:
(a) selecting contents to be displayed on the idle-mode screen of a mobile communication terminal;
(b) setting profiles for a selected channel corresponding to the contents to be displayed; and
(c) transmitting contents based on the profiles in accordance with the format of the mobile communication terminal.

9. The method as claimed in claim 7, wherein the profiles of the step (c) comprise at least one of a period in which broadcasting is performed on the idle-mode screen in the personal multimedia broadcasting system, invocation time, a contents available period, and the generation of real time information.

10. A computer readable recording medium on which programs are recorded, the programs for executing a method of extracting/converting contents in a personal computer using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of:
(a) initializing the contents to data standard and specification that are suitable for a mobile communication terminal;
(b) inputting a uniform resource locator (URL) to be extracted through the contents extraction/conversion programs;
(c) buffering data that is transmitted to a hypertext transfer protocol (HTTP) corresponding to the URL in a temporary storage space;
(d) processing the buffered data so that the contents region is easily extracted;
(e) providing the processed contents on a mobile communication terminal screen;
(f) selecting a region that is desired to be extracted from the screen on which the processed contents are provided; and
(g) the contents extraction/conversion programs converting the processed contents into data standard and specification that are suitable for a mobile communication terminal.

11. A computer readable recording medium on which programs are recorded, the programs for executing a method of transmitting contents from a personal computer to a mobile communication terminal using a system of providing contents information on the idle-mode screen of a mobile communication terminal using a personal computer that functions as a server, the system comprising an on line portal server for providing contents to a personal computer through a communication network, a personal computer in which contents extraction/conversion programs for extracting contents from the on line portal server to convert the extracted contents to be displayed on the idle-mode screen of the mobile communication terminal are built, and a mobile communication terminal for receiving the contents from the personal computer to display the received contents on the idle-mode screen, the method comprising the steps of:
(a) selecting contents to be displayed on the idle-mode screen of a mobile communication terminal;
(b) setting profiles for a selected channel corresponding to the contents to be displayed; and
(c) transmitting contents based on the profiles in accordance with the format of the mobile communication terminal.
